(19) United States
(12) Patent Application Publication
(10) Pub. No.: US 2025/0292769 A1
(43) Pub. Date: Sep. 18, 2025

(54) Collaboration Between a Recommendation Engine and a Voice Assistant

(71) Applicant: Cerence Operating Company, Burlington, MA (US)

(72) Inventors: Yu Liu, Burlington, MA (US); Bo Zhou, Burlington, MA (US); Wenbin Zhang, Burlington, MA (US); Junren Deng, Burlington, MA (US); Goujin Wei, Burlington, MA (US); Fan Luo, Burlington, MA (US)

(21) Appl. No.: 18/872,885

(22) PCT Filed: Jul. 19, 2023
(86) PCT No.: PCT/US2023/028092

§ 371 Date: Dec. 9, 2024

Related U.S. Application Data
(60) Provisional application No. 63/390,739, filed on Jul. 20, 2022.

(51) Int. Cl. G10L 15/22; G06F 16/2457; G10L 15/18; G10L 15/30

(52) U.S. Cl. CPC G10L 15/22; G06F 16/2457; G10L 15/1815; G10L 2015/223; G10L 15/30

(57) ABSTRACT

A method comprising causing a voice assistant and a recommendation engine that are executing in an infotainment system of a vehicle to cooperate in processing a vehicle occupant's acceptance of a recommendation proposed by the recommendation engine by having an interface to enable the recommendation engine to provide recommendation context to the voice assistant to enable the voice assistant to resolve an ambiguity in the occupant's acceptance of the recommendation.

### CROSS-REFERENCE TO RELATED APPLICATIONS

This application claims the benefit of U.S. Provisional Application No. 63/390,739, filed on Jul. 20, 2022, the content of which is hereby incorporated in its entirety.

### BACKGROUND

A modern motor vehicle, such as an automobile, often has an infotainment system that executes various applications. Among these is a voice assistant that executes commands uttered by an occupant of the vehicle. Thus, rather than using a switch, one can simply utter a command, such as “Turn on the lights,” or “Set cruise control.”

Another application that can be found is a recommendation engine. A recommendation engine receives information from which it is possible to infer the occupant's needs. Based on that information, the recommendation engine makes a recommendation.

### SUMMARY

The invention is based on the recognition that a synergy arises upon loosely coupling a voice assistant and a recommendation engine.

A technical advantage arises from having enabled loose coupling between the recommendation engine and the voice assistant. In particular, to the extent that the context provided by the recommendation engine is of use to the voice assistant, the recommendation engine can avoid having to mediate the interaction between the occupant and the voice assistant following a prompt provided by the recommendation engine.

In one aspect, the invention features a method that includes a voice assistant and a recommendation engine that are executing in an infotainment system of a vehicle to cooperate in processing a vehicle occupant's acceptance of a recommendation proposed by the recommendation engine. In such a method, the recommendation engine provides a recommendation to a recommendation interface that is between the voice assistant and the recommendation engine. This recommendation includes recommendation context. The method continues with the voice assistant receiving an utterance from the occupant. This utterance indicates acceptance of a recommendation but does not identify it. The voice assistant then identifies an action to be carried out. It does so based at least in part on the recommendation context and the utterance. Upon having done so, the voice assistant carries out this action.

Among the practices of the method are those in which the recommendation context includes a natural language command. These practices include those in which the natural language command, when uttered by the occupant, would cause the voice assistant to carry out the action, those in which the voice assistant to substitute the natural language command for the utterance from the occupant, and those in which the voice assistant uses the natural language command and the utterance as a basis for inferring an intent of the occupant.

Other practices include those in which the recommendation context includes a data structure and wherein the method further includes causing the voice assistant to infer an intent of the occupant based at least in part on the data structure and the utterance. Among these are practices in which the data structure is a JSON data structure.

Still other practices include those in which the recommendation context includes values of variables from context data that is used by the recommendation engine to propose a recommendation.

Still other practices of the invention include those that add, to any of the foregoing features, the step of having the recommendation engine to monitor context data and to propose the recommendation based at least in part on the context data. Among these practices are those in which the recommendation data chooses from one or more of several types of context data. These types include vehicle sensor data, application event data, content data, OEM data, and occupant data. The vehicle sensor data, which is obtained from sensors in the vehicle, includes data that is indicative of an operating state of the vehicle. The application event data includes data that is indicative of state and history of applications executing on the infotainment system. The content data includes data indicative of media content. The OEM service data includes information indicative of car maintenance events. And the occupant data includes information concerning the occupant.

Practices of any of the foregoing methods also include those in which the recommendation further includes one or more of a prompt and a context-dependent response. In those practices in which the recommendation includes a prompt, the voice assistant communicates the recommendation to the occupant by uttering the prompt. In those cases in which the recommendation further includes a context-dependent response, the context-dependent response includes what the occupant would be expected to utter as a response to a prompt that communicates the recommendation to the occupant. In this case, the context-dependent response indicates that an action is to be carried out but it omits an identification of the action.

In another aspect, the invention features causing a voice assistant and a recommendation engine that are executing in an infotainment system of a vehicle to cooperate in processing a vehicle occupant's acceptance of a recommendation proposed by the recommendation engine by having an interface to enable the recommendation engine to provide recommendation context to the voice assistant to enable the voice assistant to resolve an ambiguity in the occupant's acceptance of the recommendation.

In another aspect, the invention features an apparatus for use in a vehicle that is equipped with an infotainment system that executes a voice assistant and a recommendation engine. Such an apparatus is configured for enabling a voice assistant and a recommendation engine to cooperate in processing a spoken acceptance, by an occupant of the vehicle, of a recommendation proposed by the recommendation engine. The apparatus includes a recommendation interface that executes on the infotainment system. This recommendation interface is configured to receive the recommendation from the recommendation engine for use by the voice assistant and to make the recommendation available to the voice assistant. This recommendation includes recommendation context. The voice assistant is configured to receive an utterance from the occupant. This utterance indicates acceptance of an unidentified recommendation. The voice assistant is configured to identify an action to be carried out based at least in part on the recommendation context and to carry out the action.

Embodiments include those in which the recommendation context includes a natural language command. Among these are embodiments in which the voice assistant is configured to carry out the action upon receiving the occupant's utterance of the command specified in the recommendation context and also to do so without actually having received an utterance of that command. Also among the embodiments that include such a recommendation context are those in which the voice assistant is configured to carry out the action by substituting the command for the utterance from the occupant and those in which the voice assistant is configured to use the command and the utterance as a basis for inferring an intent of the occupant.

Further embodiments include those in which the recommendation context includes a data structure. In such embodiments, the voice assistant is further configured to infer an intent of the occupant based at least in part on the data structure and the utterance. Among these embodiments are those in which the data structure includes a JSON data structure.

Still other embodiments include a source of context data. In such embodiments, the recommendation engine is configured to rely at least in part on the context data when proposing the recommendation. Among these embodiments are those in which the recommendation context includes values of variables from the context data. Also among these are embodiments in which the recommendation engine is configured to monitor the context data and to propose the recommendation based at least in part on the context data. Still other embodiments that include the source of context data are those in which the context data upon which the recommendation engine relies include vehicle sensor data, application event data, content data, OEM data, and occupant data. The vehicle sensor data, which is obtained from sensors in the vehicle, includes data that is indicative of an operating state of the vehicle. The application event data includes data that is indicative of state and history of applications executing on the infotainment system. The content data includes data indicative of media content. The OEM service data includes information indicative of car maintenance events. And the occupant data includes information concerning the occupant.

Still other embodiments include those in which the recommendation engine is configured to provide a recommendation that further includes one or both of a prompt and a context-dependent response. In the former case, the voice assistant is configured to communicate the recommendation to the occupant by uttering the prompt. In the latter case, the context-dependent response includes what the occupant would be expected to utter as a response to a prompt that communicates the recommendation to the occupant. The context-dependent response indicates acceptance of the recommendation but omits an identification of the recommendation itself and hence the action to be carried out to accept the recommendation.

These and other features of the invention will be apparent from the following detailed description and the accompanying figures, in which:

### DESCRIPTION OF DRAWINGS

FIG. 1 shows a vehicle having an infotainment system,

FIG. 2 shows an illustrative architecture of the coupled recommendation engine executing in the infotainment system of FIG. 1,

FIG. 3 shows an example of recommendation context for the recommendation shown in FIG. 2,

FIG. 4 shows a scenario-generating procedure for preparing the voice-interaction system of FIG. 2 for use, and

FIG. 5 shows a run-time procedure carried out by the voice-interaction system of FIG. 2.

### DETAILED DESCRIPTION

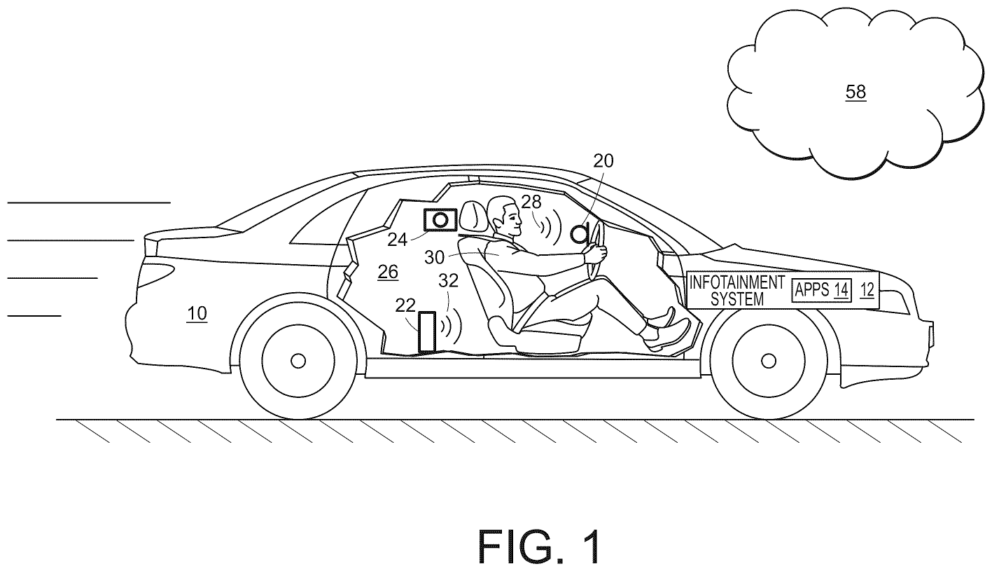

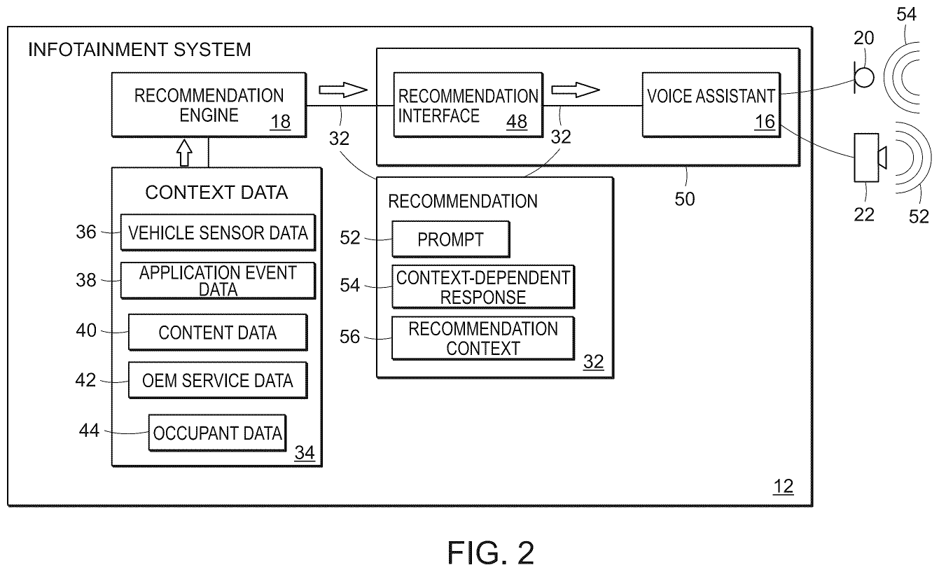

FIG. 1 shows a vehicle 10 having an infotainment system 12 that runs one or more applications 14. Among these is a voice assistant 16 and a recommendation engine 18, as shown in FIG. 2.

The infotainment system 12 couples to one or more microphones 20, loudspeakers 22, and cameras 24 that are in the vehicle's cabin 26.

The voice assistant 16 carries out various commands 28 uttered by an occupant 30 within the vehicle 10. These include commands 28 for controlling various features of the vehicle 10. Examples include commands to control the cruise control system, commands to operate the climate control system, and commands to operate the entertainment system.

Referring to FIG. 2, the recommendation engine 18 proactively offers recommendations 32 to the occupant 20 based on context data 34. This context data 24 provides a basis for anticipating the occupant's needs and thus for the formulation of a recommendation 32 for taking action that would promote the occupant's safety, security, comfort, and convenience. The recommendation engine's performance is measured by the ratio of how many offered recommendations 32 have been accepted.

The context data 34, which is what the recommendation engine 18 relies upon for making recommendations 32, includes vehicle sensor data 36, application event data 38, content data 40, OEM service data 42, and occupant data 44.

Sensor data 36 provides information on the vehicle's state. Examples of sensor data 36 include one or more of vehicle speed, current location of the vehicle, as obtained from a GPS, window status, door status, engine temperature, fuel supply, oil pressure, tire pressure, coolant supplies, mileage, elapsed time driving, gross vehicle weight, orientation of the vehicle, cabin temperature and cabin humidity.

Application event data 38 provides information on the state and history of applications executing on the infotainment system, such as media play events and information from the GPS 46 concerning the destination of the vehicle, points-of-interest, estimated time of arrival at the destination, and any waypoints. Content data 40 includes media content such as weather reports, breaking news, and traffic alerts. OEM service data 42 includes information concerning upcoming car maintenance events, a history of car maintenance events, and a schedule of such events. Occupant data 44 includes the occupant's identity, the occupant's preferences and settings, and information on the occupant's habits.

Although the voice assistant 16 and the recommendation engine 18 execute on the same infotainment system 12, they are nevertheless different applications 14 with different goals. In some cases, the voice assistant 16 and the recommendation engine 18 are made by different vendors. Thus, there is no a priori reason to expect the voice assistant 16 and the recommendation engine 18 to communicate with or otherwise interact with each other.

The occupant 30 (FIG. 1) ultimately receives a recommendation 32 via a speech interface. In some cases, the occupant 30 accepts the recommendation 32. However, a difficulty that arises is that the recommendation engine 18 has no way to act in a manner consistent with the user's acceptance. After all, it is the voice assistant 16 that executes commands 28, not the recommendation engine 18.

The occupant 30 does not perceive the voice assistant 16 and the recommendation engine 18 as being separate applications 14. As far as the occupant 30 is concerned, any voice interaction involves only a single entity, namely the infotainment system 12. This misperception can result in awkwardness in the ensuing dialog. Such awkwardness arises because the voice assistant 16 has no awareness of context created as a result of the recommendation engine's activity.

In one example, the recommendation engine 18 recognizes, based on the context data 34, that the occupant 30 is driving on a highway with no traffic and considerable time left to a programmed destination. These are ideal circumstances for the use of cruise control. And yet, the recommendation engine 18 realizes that cruise control is not engaged. As a result, the recommendation engine 18 issues the recommendation 32: “We will be on this highway for a long time. Would you like to engage cruise control?”

Upon hearing this, the occupant 30 decides to accept the recommendation 32. Consistent with normal speech, the occupant 30 replies “Yes, please.”

The voice assistant 16, whose job is to monitor the cabin 26 for utterances to act on, hears acceptance. But it does not know what is being accepted. After all, it was not the voice assistant 16 that offered the recommendation 32. Therefore, the voice assistant 16 lacks awareness of context.

In an effort to clarify matters, the voice assistant 16 says, “I'm sorry. I do not quite understand.”

The occupant 30, who is not aware that there are actually applications in play, naturally becomes vexed. After all, as far as the occupant 30 is concerned, an infotainment system 12 has made a recommendation and, seconds later, forgotten all about it.

To remedy this difficulty, there exists a recommendation interface 48 between the voice assistant 16 and the recommendation engine 18. This makes it possible for the recommendation engine 18 to provide recommendation context 48 to the voice assistant 16. Using this recommendation context 48, the voice assistant 16 is able to respond coherently to a recommendation 32 by the recommendation engine 18. As a result, the voice assistant 16 is able to respond to what would otherwise be an ambiguous utterance and to do so without seeking clarification. This enables the infotainment system 12 to behave in a manner consistent with the occupant's expectation.

In binding the recommendation engine 18 and the voice assistant 16, the recommendation interface 48 effectively defines a new voice-interaction system 50 that complies with the occupant's expectation for how communication with the infotainment system 12 should take place.

In one mode of operation, the recommendation engine 18 provides a recommendation 32 to the recommendation interface 48, which then makes it available to the voice assistant 16. The recommendation 32 includes a prompt 52. This prompt 52 is the actual utterance that communicates the recommendation 32 to the occupant 30. As an example, a prompt 52 asks the occupant 30 if a particular feature should be activated (e.g., “Do you want to turn on ‘cruise control’?”).

However, in addition to the prompt 52, the recommendation 32 includes a context-dependent response 54 and a recommendation context 56.

A context-dependent response 54 is what the occupant 30 would be expected to utter as a response to the prompt 52. Because the recommendation engine 18 proactively initiated the dialog, the context-dependent response 54 would naturally assume that the infotainment system 12 is aware of context. As such, the context-dependent response 54 would normally include an ambiguity. This ambiguity arises because the occupant 30 reasonably assumes that the infotainment system 12 will resolve the ambiguity in much the same way a person would resolve it.

A context-dependent response 54 typically takes the form of a statement that either accepts or rejects the recommendation 32 while omitting the substance of the recommendation 32. Thus, in response to the prompt 52, “Do you want to turn on cruise control?” an affirmative context-dependent response 54 would be an utterance such as “Yes,” “OK,” “Why not?” and the like whereas a negative context-dependent response 54 might be “No, thanks.” In both cases, the context-dependent response 54 is devoid of context.

The third component of the recommendation 32, namely the recommendation context 56, provides the voice assistant 16 with information on what to actually do upon receiving the context-dependent response 54. This enables the voice assistant 16 to act even though the context-dependent response 54 omits the substance of the recommendation 32.

Embodiments include those in which the recommendation context 56 represents a linguistic input that is provided to the voice assistant 16 for processing. Examples of “linguistic input” include text (e.g., a sequence of words) or an audio signal representative of a sequence of words.

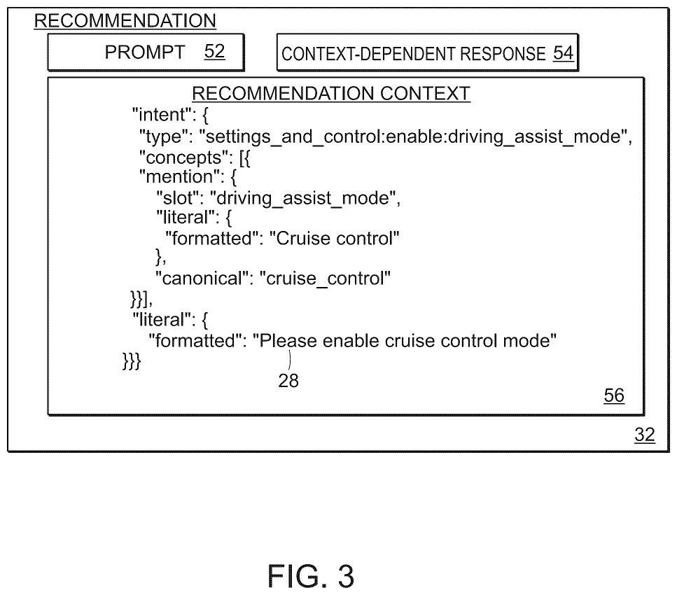

For example, FIG. 3 shows a recommendation 32 in which the recommendation context 56 is essentially what an occupant 30 would have been expected to utter in order to execute the particular command 28 that would carry out the recommendation 32. Thus, in FIG. 3, the recommendation context 56 causes the voice assistant 16 to respond to an affirmative context-dependent response 54 (e.g., “Sure, go ahead”) by remedying its deficiency in context and acting as if the occupant 30 had instead uttered “Please enable cruise control.” In effect, the recommendation context 56 could be said to have “put words in the occupant's mouth.”

However, this is not the only way to implement the recommendation context 56. In other embodiments, the recommendation context 56 represents a data structure, like the command 28 shown in FIG. 3, also represents the occupant's intent. Embodiments include those in which the data structure is a JSON structure, those in which it is produced by a natural language understanding component of the voice assistant 16, and those in which the data structure is processed in a manner similar to how an intent embedded in an occupant-initiated command 28 would have been processed by the voice assistant 16's natural-language component. This is a particularly useful feature when the command 28 would be complicated or when it includes variables, such information from the context data 34.

In some embodiments, the recommendation context 56 includes a second prompt 52 that is provided to the occupant 30 only if the occupant 30 has responded with the expected context-dependent response 54.

In some embodiments, the recommendation engine 18 provides more than one recommendation context 56, each of which is associated with a context-dependent response 54. In such embodiments, the recommendation interface 48 matches the occupant's context-dependent response 54 to that associated with each of the contexts 56 and provides an associated recommendation context 56 to the voice assistant 16.

In some embodiments, the recommendation engine 18 provides a recommendation in response to a state that is external to the infotainment system 12. Examples of such a state information include state derived from the context data 34.

In some embodiments, the process of configuring the voice-interaction system 50 for operation includes adding recommendations 32 corresponding to different states derived from the context data 34.

In some embodiments, the components of the voice-interaction system 50 are distributed across multiple locations. Among these are embodiments in which the recommendation interface 48 is co-located with the occupant 30, such as hosted in the occupant's device. Also among the embodiments are those in which one or both of the recommendation engine 18 and the voice assistant 16 are hosted, at least in part, in a computing facility removed from the occupant 30, such as in a cloud server 58 that is in data communication with the vehicle 10, as shown in FIG. 1.

Embodiments include those in which some of the voice assistant 16, the recommendation engine 18, and the recommendation interface 48 are implemented in software that is stored on a non-transitory machine-readable medium and that when executed by one or more processor, for example by circuitry on a physical integrated circuit, of the system causes performance of steps set forth above.

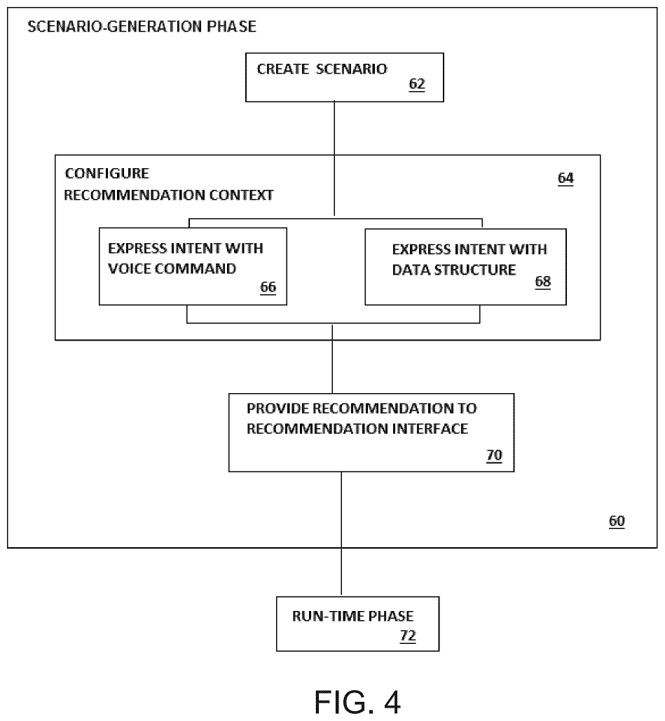

Referring to FIG. 4, a scenario-generation phase 60 for configuring voice-interaction system 50 is carried out by a scenario developer who carries out a scenario creation step (step 62). In some practices, the scenario developer is a human being who generates the scenario using an application program interface. In others, the scenario developer is an artificially intelligent entity, such as a generative model or a large language model. Among these are embodiments are those in which a human being provides prompts to the artificially intelligent entity.

This step includes identifying conditions that will trigger a recommendation 32. For each recommendation 32 that the recommendation engine 18 is capable of making, identifying a pattern of context data 34 that would result in making that recommendation 32. For example, before making the aforementioned recommendation 32 concerning cruise control, the context data 34 should indicate that: the occupant 30 has been driving on a highway for more than ten minute, that there is presently no significant traffic, that there remain thirty minutes of travel on the highway, and of course, that cruise control is not already engaged. All of this information is easily derivable from the aforementioned context data 34.

The process continues with the step of configuring the recommendation context 56 (step 64). There are two modes for carrying this out. These correspond to different ways of filling in the occupant's intent so that the voice assistant 16 will know what to do.

In the first mode (step 66), the recommendation context 56 includes the user-initiated voice command 28. This is the case in which the recommendation 32 would include, as an example, the recommendation context 56 as shown in FIG. 3. This is then provided to the recommendation interface 48, which then makes it available to the voice assistant 16 wherever the voice assistant 16 resides. As a result, the voice assistant 16 responds to an affirmative context-dependent response 54 by acting as if it had actually received a user-initiated command 28 to carry out the relevant function, which in the illustrated case is to engage the cruise control.

The second mode (step 68) expresses the occupant's intent using a data structure. In one option the recommendation context 56 is configured directly with JSON. This is useful for those cases in which the recommendation context 56 is too complex and unwieldy to be described as shown in FIG. 3. Such complexity can arise, for example, if the scenario developer wishes to include a variable, such as the vehicle's current speed. In the context of the illustrated example, given the vehicle's location it is possible to obtain the speed limit, in which case the speed limit could be supplied as a variable for setting cruise control.

The ability to configure the recommendation context 56 directly in JSON is also useful to support collaboration with any voice assistant 16 that complies with the relevant standard. This promotes the ability to collaborate voice assistants 16 made by different manufacturers.

In many cases, a voice assistant 16 runs in hybrid mode, with complex utterances being handled by the cloud server 58 and simple requests to control vehicular features being executed by the vehicle's infotainment system 12. For a particular recommendation 32, the scenario developer generally knows what acceptance of the recommendation 32 will require. As a result, in the second mode (step 68) the scenario developer has the opportunity to specify how to route the context-dependent response 54 for proper handling. This is also made possible by using the second mode.

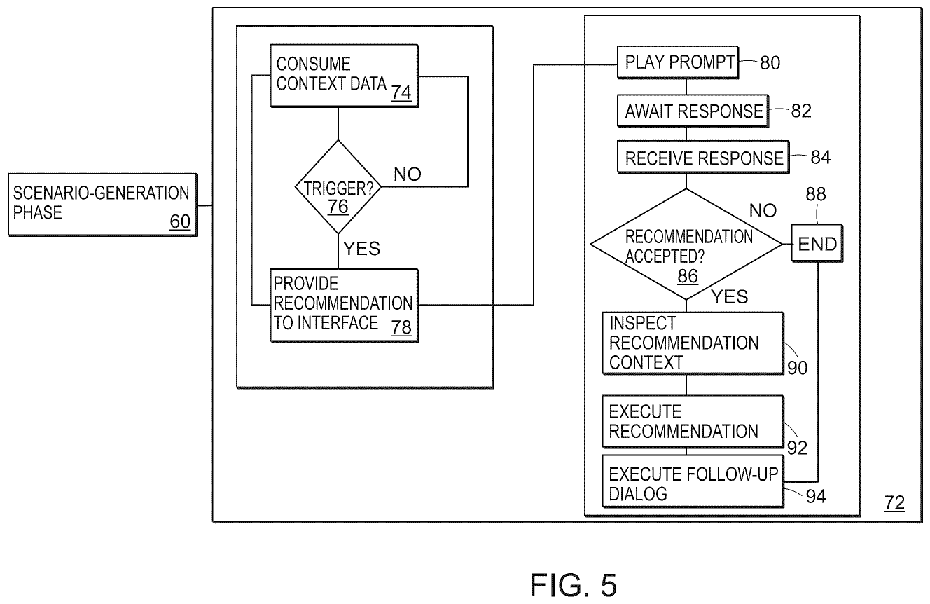

With the recommendation context 56 having been configured, the recommendation is then provided to the recommendation interface 48 (step 70) so that it is available for use in a run-time phase 72 that follows, the details of which are shown in FIG. 5.

Referring now to FIG. 5, a runtime method 72 includes the recommendation engine 18 consuming context data 34 (step 74) to decide whether to trigger any of the scenarios developed by the scenario developer (step 76). If so, the recommendation engine 18 provides a recommendation 32 corresponding to that scenario to the recommendation interface 48 to be made available to the voice assistant 14 (step 78). As noted earlier, this recommendation 32 includes both the context dependent response 54 and the recommendation context 56.

Upon receiving the recommendation 32, the voice assistant 16 activates a text-to-speech interface to play the recommendation's prompt 52 through the loudspeaker 24 (step 80) and activates the microphone 22 to await a response from the occupant 30 (step 82). Upon receiving a response (step 84), the voice assistant 16 classifies the response as having been accepted or not accepted (step 86). As used herein, absence of a relevant utterance after lapse of a time-out period is considered a null response and classified as the recommendation 32 having been ignored.

If the recommendation 32 has not been accepted, either as a result of an affirmative rejection or a time out, processing ends (step 88).

In those cases in which the recommendation 32 has been accepted, for example with an utterance such as “Yes, please” or “OK,” the infotainment system 12 typically handles the request. This includes extracting the recommendation context 56 (step 90) and executing the recommendation based on the recommendation context (step 92) as well as carrying out any follow-up dialog (step 94).

In the embodiment discussed herein, the voice assistant 16, or that portion thereof that executes on the infotainment system 12 enables cruise control mode (step 92) and confirms the action with suitable follow-up dialog, such as: “Cruise control is on and set to sixty-five miles per hour. You can say ‘Disengage Cruise Control’ at any disengage cruise control” (step 94). At this point, the voice assistant 16 deactivates the microphone 22 and ends processing (step 88).

Having described the invention and a preferred embodiment thereof, what is claimed as new and secured by Letters Patent is:

1. A method comprising causing a voice assistant and a recommendation engine that are executing in an infotainment system of a vehicle to cooperate in processing a vehicle occupant's acceptance of a recommendation proposed by said recommendation engine, wherein causing said voice assistant and said recommendation engine to cooperate comprises:
causing said recommendation engine to provide a recommendation to a recommendation interface that is between said voice assistant and said recommendation engine, said recommendation comprising a recommendation context,
receiving, by said voice assistant, an utterance from said occupant, wherein said utterance indicates acceptance of an unidentified recommendation,
causing said voice assistant to identify an action to be carried out based at least in part on said recommendation context and said utterance, and
causing said voice assistant to carry out said action.

2. The method of claim 1, wherein said recommendation context comprises a natural language command that, when uttered by said occupant, would cause said voice assistant to carry out said action, wherein causing said voice assistant to carry out said action comprises causing said voice assistant to carry out said action without said occupant having uttered said command.

3. The method of claim 1, wherein said recommendation context comprises a natural language command and wherein causing said voice assistant to carry out said action comprises causing said voice assistant to substitute said natural language command for said utterance from said occupant.

4. The method of claim 1, wherein said recommendation context comprises a natural language command and wherein said method further comprises said voice assistant using said natural language command and said utterance as a basis for inferring an intent of said occupant.

5. The method of claim 1, wherein said recommendation context comprises a data structure and wherein said method further comprises causing said voice assistant to infer an intent of said occupant based at least in part on said data structure and said utterance.

6. The method of claim 1, wherein said recommendation context comprises a JSON data structure and wherein said method further comprises causing said voice assistant to infer an intent of said occupant based at least in part on said JSON data structure and said utterance.

7. The method of claim 1, wherein said recommendation context comprises values of variables from context data that is used by said recommendation engine to propose a recommendation.

8. The method of claim 1, further comprising causing said recommendation engine to monitor context data and to propose said recommendation based at least in part on said context data.

9. The method of claim 1, further comprising causing said recommendation engine to monitor context data and to propose said recommendation based at least in part on said context data, wherein said context data comprises vehicle sensor data, application event data, content data, OEM data, and occupant data, wherein said vehicle sensor data, which is obtained from sensors in said vehicle, comprises data that is indicative of an operating state of said vehicle, wherein said application event data comprises data that is indicative of state and history of applications executing on said infotainment system, wherein said content data comprises data indicative of media content, wherein OEM service data comprises information indicative of car maintenance events, and wherein occupant data comprises information concerning said occupant.

10. The method of claim 1, wherein said recommendation further comprises a prompt and wherein said method further comprises causing said voice assistant to communicate said recommendation to said occupant by uttering said prompt.

11. The method of claim 1, wherein said recommendation further comprises a context-dependent response, wherein said context-dependent response comprises what said occupant would be expected to utter as a response to a prompt that communicates said recommendation to said occupant, wherein said context-dependent response indicates that an action is to be carried out, and wherein said context-dependent response omits an identification of said action.

12. An apparatus for use in a vehicle that is equipped with an infotainment system that executes a voice assistant and a recommendation engine, wherein said apparatus is configured for enabling a voice assistant and a recommendation engine to cooperate in processing a spoken acceptance, by an occupant of said vehicle, of a recommendation proposed by said recommendation engine, wherein said apparatus comprises a recommendation interface that executes on said infotainment system, wherein said recommendation interface is configured to receive said recommendation from said recommendation engine for use by said voice assistant and to make said recommendation available to said voice assistant, wherein said recommendation comprises recommendation context, wherein said voice assistant is configure to receive an utterance from said occupant, said utterance indicating acceptance of an unidentified recommendation, wherein said voice assistant is configured to identify an action to be carried out based at least in part on said recommendation context and to carry out said action.

13. The apparatus of claim 12, wherein said recommendation context comprises a natural language command and wherein said voice assistant is configured to carry out said action upon receiving an utterance, by said occupant, of said command and to do so without said occupant having uttered said command.

14. The apparatus of claim 12, wherein said recommendation context comprises a command and wherein said voice assistant is configured to carry out said action by substituting said command for said utterance from said occupant, said command being a natural language command.

15. The apparatus of claim 12, wherein said recommendation context comprises command and wherein said voice assistant is configured to use said command and said utterance as a basis for inferring an intent of said occupant, wherein said command is a natural language command.

16. The apparatus of claim 12, wherein said recommendation context comprises a data structure and wherein said voice assistant is further configured to infer an intent of said occupant based at least in part on said data structure and said utterance.

17. The apparatus of claim 12, wherein said recommendation context comprises a JSON data structure and wherein said and wherein said voice assistant is further configured to infer an intent of said occupant based at least in part on said JSON data structure and said utterance.

18. The apparatus of claim 12, further comprising a source of context data, wherein said recommendation engine is configured to rely at least in part on said context data when proposing said recommendation, and wherein said recommendation context comprises values of variables from said context data.

19. The apparatus of claim 12, further comprising a source of context data, wherein said recommendation engine is configured to monitor said context data and to propose said recommendation based at least in part on said context data.

20. The apparatus of claim 12, further comprising a source of context data, wherein said recommendation engine is configured to monitor context data and to propose said recommendation based on said context data, wherein said context data comprises vehicle sensor data, application event data, content data, OEM data, and occupant data, wherein said vehicle sensor data, which is obtained from sensors in said vehicle, comprises data that is indicative of an operating state of said vehicle, wherein said application event data comprises data that is indicative of state and history of applications executing on said infotainment system, wherein said content data comprises data indicative of media content, wherein OEM service data comprises information indicative of car maintenance events, and wherein occupant data comprises information concerning said occupant.

21. The apparatus of claim 12, wherein said recommendation further is configured to provide a recommendation that further comprises a prompt and wherein said voice assistant is configured to communicate said recommendation to said occupant by uttering said prompt.

22. The apparatus of claim 12, wherein said recommendation engine if configured to provide a recommendation that further comprises a context-dependent response, wherein said context-dependent response comprises what said occupant would be expected to utter as a response to a prompt that communicates said recommendation to said occupant, wherein said context-dependent response indicates that an action is to be carried out, and wherein said context-dependent response omits an identification of said action.
